(19) United States
(12) Patent Application Publication
(10) Pub. No.: US 2024/0092621 A1
(43) Pub. Date: Mar. 21, 2024

(54) SELF-PROPELLED WORK VEHICLE

(71) Applicant: MAGNI REAL ESTATE S.R.L., CASTELFRANCO EMILIA (IT)

(72) Inventor: Riccardo MAGNI, MODENA (IT)

(73) Assignee: MAGNI REAL ESTATE S.R.L., CASTELFRANCO EMILIA (IT)

(21) Appl. No.: 18/283,679

(22) PCT Filed: Mar. 17, 2022
(86) PCT No.: PCT/EP2022/057060

§ 371 Date: Sep. 22, 2023

(30) Foreign Application Priority Data
Mar. 25, 2021 (IT) 102021000007268

(51) Int. Cl. B66F 11/04

(52) U.S. Cl. CPC B66F 11/046

(57) ABSTRACT

A self-propelled work vehicle, which comprises at least one vehicle which supports at least one main telescopic arm, which is coupled with a first end to the vehicle and supports a work apparatus at the opposite end; the apparatus comprises elements for moving a work platform which is adapted to accommodate at least one operator; the moving elements are configured to move the platform with respect to the main arm and to support the platform in a plurality of different work positions; the moving elements are supported rotatably by the main arm by way of an axial bearing, which is adapted to support the elements in one configuration chosen among at least one first working configuration and one second working configuration, which can be obtained from the first with a rotation of the elements with respect to the main arm equal to a predefined angle.

The present invention relates to a self-propelled work vehicle.

As is known, the heterogeneous sector of self-propelled work vehicles includes vehicles (also known as “aerial platforms”) that make it possible for an operator to carry out professional activities of a various nature at raised heights, for example for bridge maintenance or reinforcement, to repair pipes or infrastructure located several meters from the ground, etc.

In one of the most common embodiments, such means therefore comprise a vehicle provided with wheels or crawler tracks in order to be able to move over ground and with an apparatus for lifting a work platform, that is a kind of cage or basket designed to accommodate the operator in safety so that he can carry out the set task at the desired height.

In such context, the lifting apparatus usually comprises one or more arms, telescopic or not, and which optionally are mutually articulated: the relative movement of the arms (and of the apparatus with respect to the vehicle) makes it possible to lift the platform in a greater or lesser number of working configurations, in order to ensure in any case sufficient versatility and the placing of the platform in the desired position even in the presence of environmental constraints that limit the vehicle's ability to move and/or extend its arms.

Although they are able to operate in a large number of different practical conditions, self-propelled work vehicles are still configured and dimensioned to lift the operator and bring him or her to work at a determined (positive) height above the ground: such vehicles are not capable of lowering the platform to a lower level, below road level, as is sometimes in fact required. For example in fact, in some cases the operator needs to be lowered down beside a bridge or a road, in order to work while suspended below the level of the road on which the vehicle supporting the operator is parked.

To use conventional vehicles in these contexts as well, the manual disassembly and reassembly is required of some components of the lifting apparatus, so as to modify their configuration and enable the platform to be lowered instead of raised.

In any case these solutions are not devoid of drawbacks, in that manual intervention in any case requires considerable timescales, is often difficult and, if not carried out under optimal conditions, even hazardous.

The aim of the present invention is to solve the above mentioned problems, by providing a self-propelled work vehicle that is capable of operating effectively both to lift and to lower its work platform.

Within this aim, an object of the invention is to provide an apparatus that can be installed on a self-propelled work vehicle which makes it possible to operate effectively both for lifting and for lowering its work platform.

Another object of the invention is to provide a self-propelled work vehicle and an apparatus that make it possible to pass easily and safely from a configuration adapted to lifting the platform to a configuration for lowering the platform, including below road level.

Another object of the invention is to provide a self-propelled work vehicle and an apparatus that ensure a high reliability of operation.

Another object of the invention is to provide a self-propelled work vehicle and an apparatus that adopt an alternative technical and structural architecture to those of conventional vehicles.

Another object of the invention is to provide a self-propelled work vehicle and an apparatus that can be easily obtained starting with elements and materials that are readily available on the market.

Another object of the invention is to provide a self-propelled work vehicle and an apparatus that are of low cost and safely applied.

This aim and these and other objects which will become better apparent hereinafter are achieved by a self-propelled work vehicle according to claim 1 and by an apparatus according to claim 9.

Further characteristics and advantages of the invention will become better apparent from the detailed description that follows of a preferred, but not exclusive, embodiment of the vehicle and of the apparatus according to the invention, which is illustrated by way of non-limiting example in the accompanying drawings wherein:

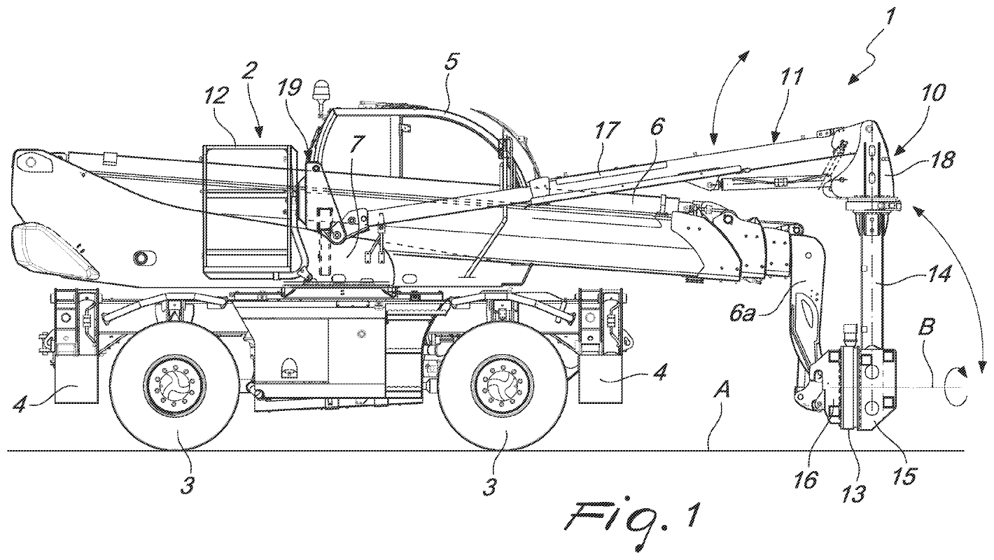

FIG. 1 is a side view of the self-propelled work vehicle according to the invention, in a configuration adapted for transfer by road;

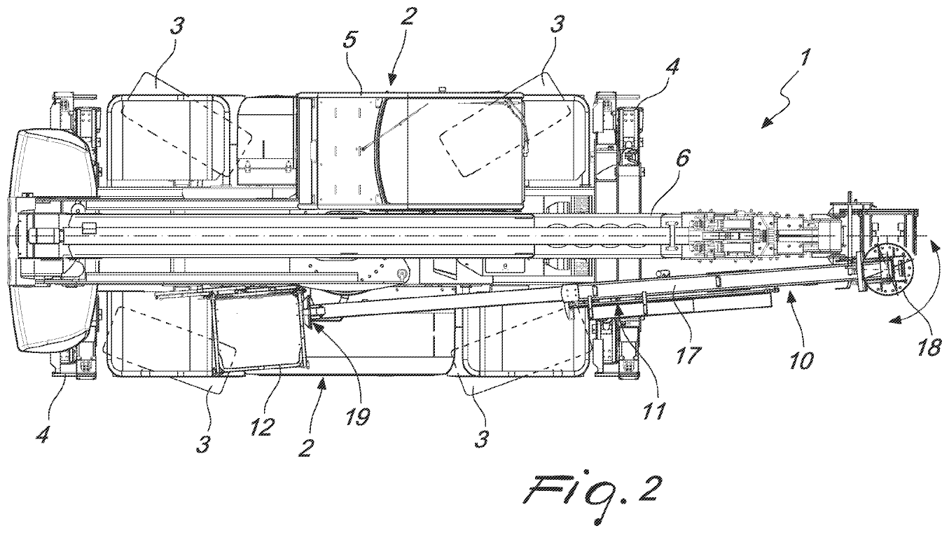

FIG. 2 is a view from above of the vehicle of FIG. 1;

FIG. 3 is a side view of the work vehicle of FIG. 1, showing the different work positions of the platform that can be obtained with the means in the first working configuration;

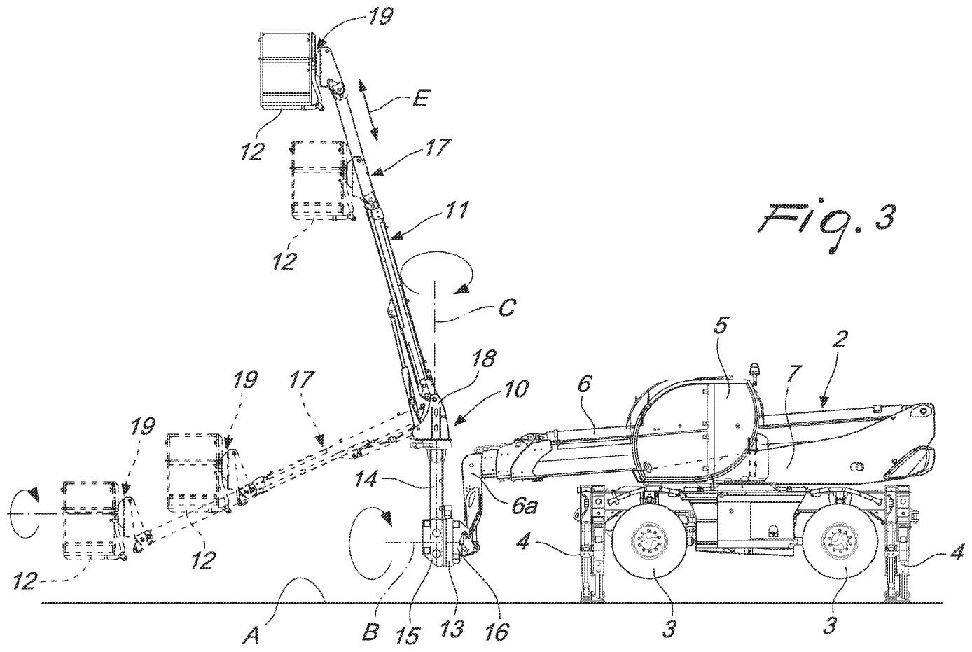

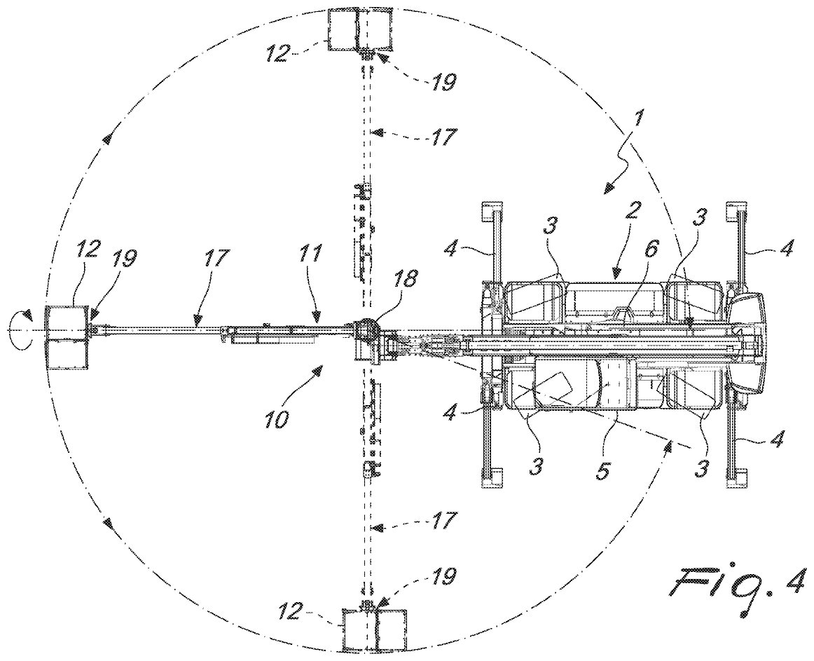

FIG. 4 is a view from above of the vehicle of FIG. 3, showing further work positions of the platform;

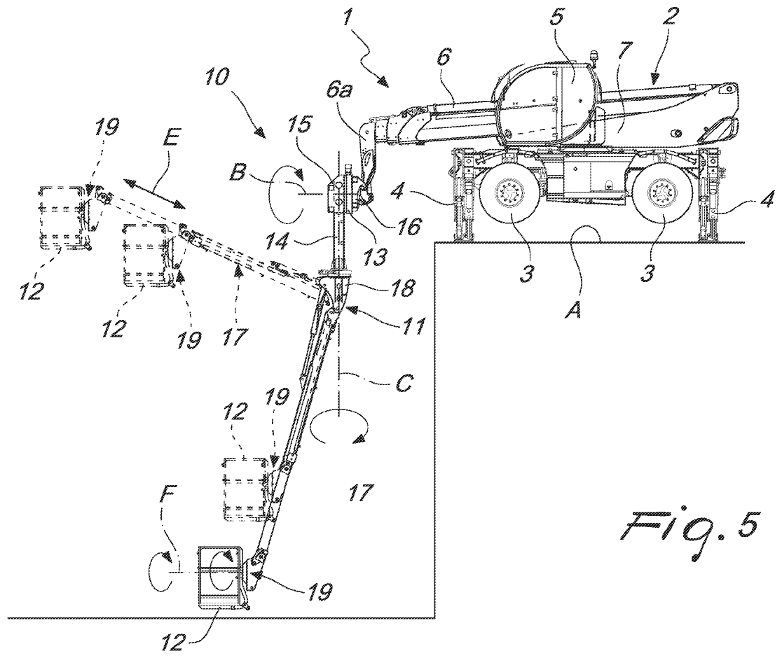

FIG. 5 is a side view of the work vehicle of FIG. 1, showing the different work positions of the platform that can be obtained with the means in the second working configuration;

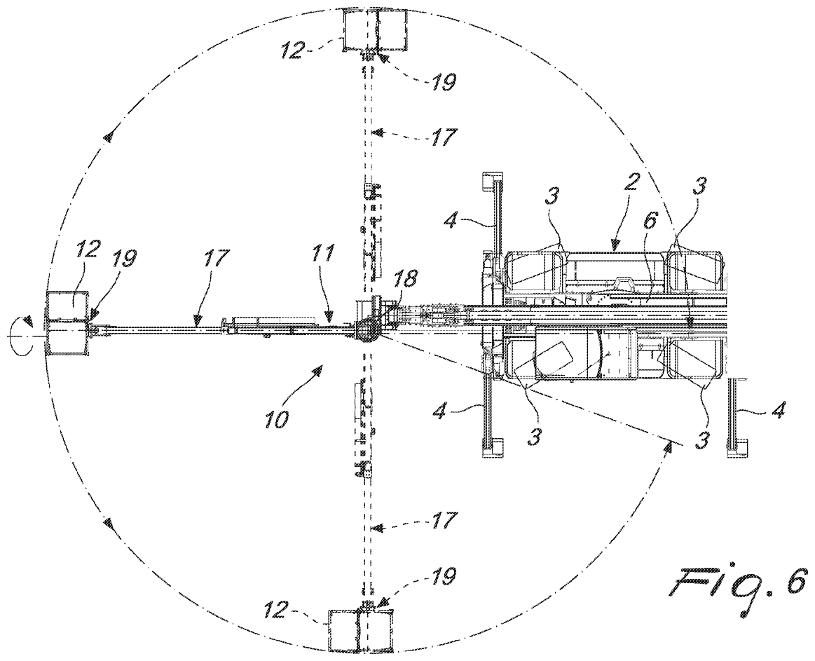

FIG. 6 is a view from above of the vehicle of FIG. 5, showing further work positions of the platform;

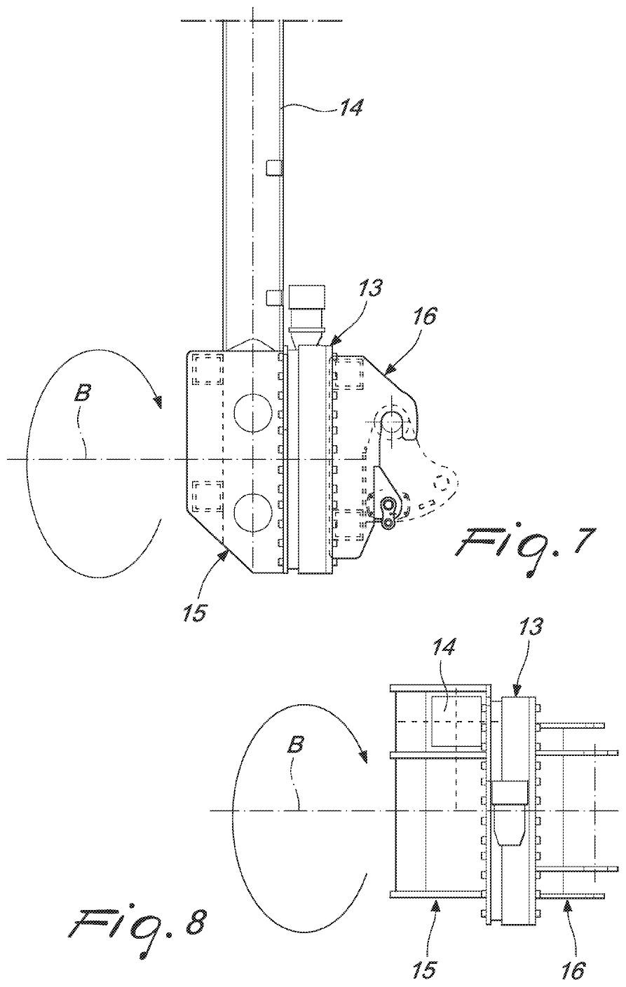

FIG. 7 is a side view of a subassembly of the vehicle of FIG. 1, which comprises the axial bearing, in the same arrangement of FIG. 3;

FIG. 8 is a view from above of the subassembly of FIG. 7;

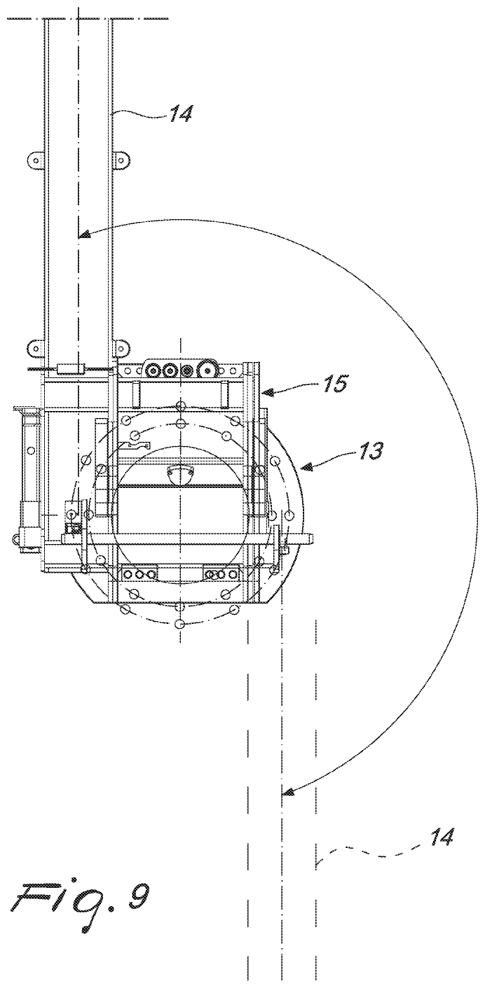

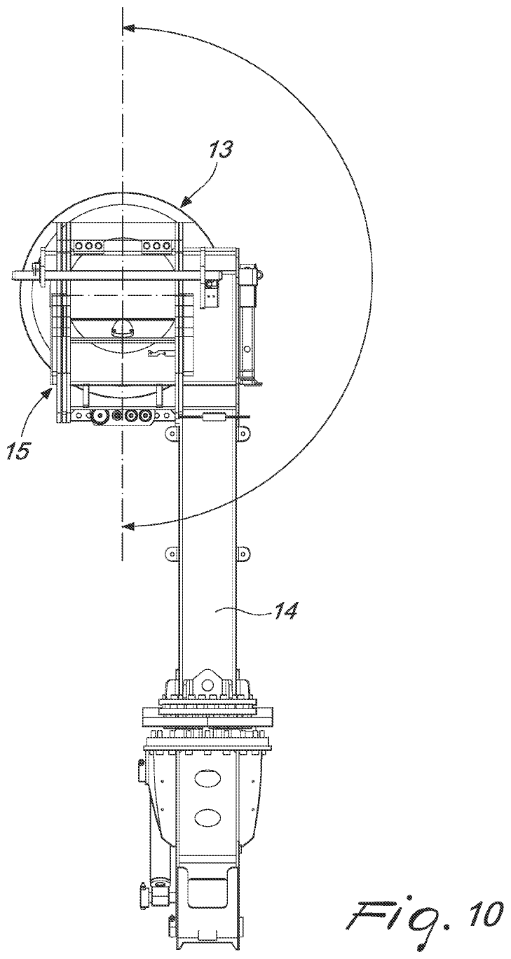

FIG. 9 is a view from the front of the subassembly of FIG. 7;

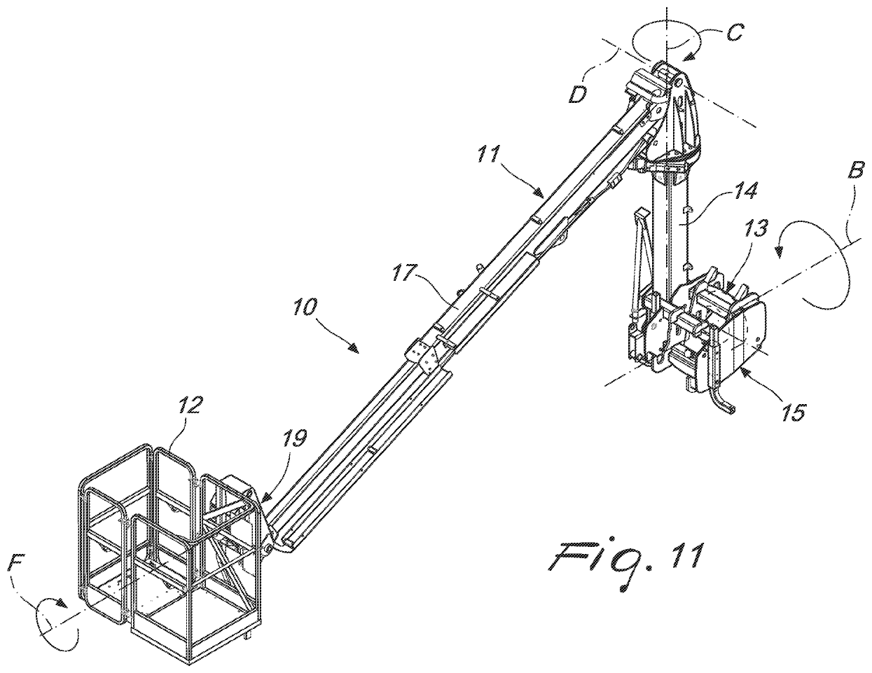

FIG. 10 is a view from the front of the subassembly of FIG. 7, seen in the arrangement of FIG. 5;

FIG. 11 is a perspective view of the apparatus according to the invention.

With particular reference to the figures, the reference numeral 1 generally designates a self-propelled work vehicle comprising at least one vehicle 2, which can move over ground A (be it the road surface, agricultural land or any other supporting surface on which the vehicle 1 is called on to operate and/or over which it can in any case travel). The vehicle 2 can be of the conventional type and be constituted by any model that the person skilled in the art would consider adapted for the task, and can likewise be provided with all accessories and contrivances typically used in the sector, according to the specific requirements. Purely for the purposes of example therefore, it is possible for the vehicle 2 to be provided with wheels 3, crawler tracks or the like, in order to allow movement over ground A, and also with stabilizers 4, which are adapted to provide a more solid and more secure stability on the ground A, when the vehicle 1 is used to carry out the tasks for which it is designed (FIGS. 3 and 5 for example). Furthermore, typically (but not necessarily) a cabin 5, intended to accommodate an operator, is mounted on the chassis of the vehicle 2.

The vehicle 2 supports a main telescopic arm 6, which is directly or indirectly coupled with a first end to the vehicle 2. The main arm 6 comprises two or more telescopic members, which are mutually slideable and retractable on command (according to methods that are known per se). By “first end” of the main arm 6 what is meant therefore is the first end of the first member, which contains partially or completely the other members when they are retracted in the configuration of minimal space occupation, usually adopted when the vehicle 1 is traveling over ground A (the vehicle 1 is shown in this configuration in the accompanying FIGS. 1 and 2).

The main arm 6 can be directly articulated to the vehicle 2 (and therefore only able to rotate about a horizontal rotation axis) or, as in the accompanying figures, it can be articulated (about a horizontal axis) to a rotatable base 7, coupled to the vehicle 2 through a rotary coupling (about a vertical axis), so as to confer an additional degree of freedom on the main arm 6.

The main arm 6 supports a work apparatus 10 on the opposite end from the first end (and from the vehicle 2). Effectively, the apparatus 10 is mounted at the second end of the main arm 6, which is opposite to the first end and coincides with the free end of the last of the series of telescopic members that, as has been seen, make up the telescopic arm 6.

In more detail, in the preferred embodiment the last member of the main arm 6 is typically provided with an appendage 6a that extends transversely (downward) with respect to the rest of the main arm 6 and to the direction of extension/retraction. The means 11 are secured right at the free end of this appendage 6a. The appendage 6a can also not be a part of the last member, but be articulated to it, in order to confer an additional degree of freedom on the system.

According to the invention, the apparatus 10 comprises means for movement 11 of a work platform 12, which is adapted to accommodate at least one operator: owing to the presence of such elements, and also with the innovative peculiarity that will be explained below, the vehicle 1 can be included in the category of “aerial platforms”. In more detail, and as can also be seen from the accompanying figures, the platform 12 is a kind of cage or basket which includes a floor on which the operator stands and (mesh) walls that rise from the sides of the floor, in order to delimit the area available to the operator, protecting him or her from accidental falls and from impacts against surrounding elements. The platform 12 can be conventional and can comprise contrivances and accessories of various nature, according to the specific requirements: typically in any case, it is provided with a control panel (for controlling the means 11 for example) and with all the safety contrivances necessary to ensure the safety of the person working on it.

The means 11 are configured for moving the platform 12 with respect to the main arm 6 and for supporting the platform 12 itself in a plurality of different work positions. In other words, the vehicle 1 offers first of all the possibility to move the entire apparatus 10 (the means 11 and the platform 12) by acting on the main arm 6 (rotating it with respect to the vehicle 2 and extending/retracting its members); furthermore, even when keeping the main arm 6 immobile the means 11 offer many additional modes of movement of the platform 12 (to which we will return below), which can thus be deployed in a great many work positions (some of which are shown in unbroken and dotted lines in FIGS. 3-6).

The means 11 are rotatably supported by the main arm 6 by way of an axial bearing 13 (interposed between the means 11 and the main arm 6); the bearing 13 is adapted to support the means 11 in one configuration chosen from among at least one first working configuration and one second working configuration, which can be obtained from the first configuration with a rotation of the means 11 with respect to the main arm 6 equal to a predefined angle.

In particular, in the preferred embodiment, and in the accompanying figures, the predefined angle is equal to 180°.

As is known, bearings are elements that make it possible to connect two components in motion with respect to each other, thus reducing friction. They typically comprise two annular rings or races which are rendered respectively integral with the components of interest; rolling elements such as balls, rollers or the like are arranged and rendered captive between the races, in order to allow relative motion between the components. In particular, axial bearings 13 are configured to support axial loads, i.e. loads oriented according to the main axis B of the bearing itself (the common axis of its annular races). The rotation between the working configurations of the means 11 occurs about the main axis B of the axial bearing 13. Such main axis B is preferably chosen and kept parallel to the ideal resting plane and/or to the ground A and oriented in the advancement direction of the vehicle 2.

Therefore the set aim is already achieved: in the first working configuration (similar to that of conventional solutions), the means 11 can lift the platform 12 to different heights, in order to reach work positions at greater or lesser heights from the ground A and from the second end of the main arm 6 (FIG. 3). By virtue of the axial bearing 13, the means 11 and the platform 12 can be easily and rapidly rotated with respect to the main axis B (with respect to the advancement direction of the vehicle 2), preferably by 180°, thus making it possible to offer in total safety a new plurality of work positions (in the case of the 180° rotation, mirror-symmetrical to the previous work positions on a horizontal plane). Thus the possibility is obtained of lowering the platform 12 with respect to the ground A and with respect to the second end of the main arm 6 (FIG. 5).

In this context, use is made of any type of axial bearing 13, according to the specific requirements.

Likewise, in the preferred embodiment (and in the accompanying figures) this axial bearing 13 is a center bearing, which as is known is indicated for use at low rotation speeds and high axial loads, such as those required by the vehicle 1.

Moreover the possibility is not ruled out of the vehicle 1 being configured to operate in further working configurations, obtainable by rotating the means 11 further about the main axis B or through different angles.

Usefully, the vehicle 1 comprises an (automatic) apparatus for actuating the rotation of the means 11 between the configurations; while noting that the methods with which the means 11 are rotated between the working configurations can be any, preferably this apparatus is of the hydraulic type.

In such context therefore, it is envisaged to provide the vehicle 1 with a hydraulic cylinder that, using adapted transmission elements, is capable on command of actuating the rotation of the means 11 with respect to the main arm 6. This hydraulic apparatus can be the same one responsible for the movement of the other moving parts of the vehicle 1, such as for example the main arm 6, the cabin 5 (if mounted on the rotating base 7), etc.

The possibility is not ruled out however of adopting a dedicated apparatus, for actuating the means 11, and also different types of operation and power supply (using an oil hydraulic or electric system, for example). In any case, preferably the apparatus can be actuated automatically by the operator, who can thus bring the vehicle 1 from the first working configuration to the second (and vice versa) in a very easy manner.

In the preferred embodiment, which in any case does not limit the application of the invention, the means 11 comprise a post 14 which is anchored with a first end portion to a supporting element 15 which is integral with a first annular race of the axial bearing 13, which as has been seen can rotate with respect to a second annular race of that axial bearing 13. Such second race is rendered integral with a second end of the main arm 6 (to the appendage 6a), opposite to the first end.

By virtue of the axial bearing 13, the rotation of the means 11 therefore consists of a rotation of the post 14 and of all the components supported thereby (including obviously the platform 12) with respect to the main arm 6.

The post 14, like the main arm 6, can also be telescopic and therefore can comprise two or more mutually extractable members (the movements being preferably activated by the above mentioned actuation apparatus). Usefully, this makes it possible to confer an additional degree of freedom on the apparatus 10 and in particular further possibilities for positioning the platform 12.

In more detail, in the preferred embodiment, in which the angle between the two working configurations is equal to 180°, in both the post 14 is kept vertical (at right angles to the ground A): in the first working configuration the post 14 extends upward with respect to the axial bearing 13 and to the second end of the main arm 6 (see for example, in this regard, FIGS. 3, 7 and 9), while in the second configuration the post 14 extends downward with respect to the axial bearing 13 and to the second end of the main arm 6 (FIGS. 5 and 10).

FIG. 9 shows the post 14 in the first configuration (unbroken lines) and in the second configuration (dotted lines), confirming that in the preferred solution the transition from one to the other corresponds preferably to a rotation of 180° (about the main axis B).

As shown in FIG. 1, the upward deployment of the post 14 (first working configuration) is particularly indicated also for the transfer of the vehicle 1, in that it makes it possible to contain the overall encumbrance as far as possible (by conveniently arranging the platform 12 and the rest of the means 11).

The supporting element 15 can comprise a bracket which can be anchored to the first annular race of the axial bearing 13 and can be chosen to be of the quick coupling type.

It should be noted that the coupling of the second end of the main arm 6 to the second annular race of the axial bearing 13 can also be obtained using a connecting element 16 of the quick coupling type.

To keep the post 14 vertical and the main axis B of the axial bearing 13 horizontal, including as a consequence of the rotation of the main arm 6 (which preferably is articulated to the vehicle 2 and therefore mobile) it is envisaged to adopt a connecting element 16 that allows the axial bearing 13 to rotate with respect to the main arm 6. Thus, each rotation of the main arm 6 corresponds to an equal and opposite rotation of the axial bearing 13, which keeps its orientation and that of the main axis B unaltered.

With further reference to the preferred embodiment, and to the accompanying figures, the means 11 comprise an auxiliary telescopic arm 17 which is adapted for the movement and the direct or indirect support (i.e., with the possible interposition of other components) of the platform 12.

The auxiliary arm 17 thus has two or more mutually extractable members (the movements being preferably activated by the above mentioned actuation apparatus), like the main arm 6.

Although it is possible for the means 11 to comprise only the auxiliary arm 17, in the preferred form they comprise both it and the post 14.

More specifically, usefully the auxiliary arm 17 can be articulated to a footing 18 which in turn is coupled rotatably to the post 14, with the ability to rotate coaxially with respect to the latter.

In other words, first of all the rotatable footing 18 can rotate about a first rotation axis C (indicated for example in FIGS. 1, 3 and 5), coaxial to the post 14 and therefore vertical (perpendicular to the resting surface of the vehicle 1 and to the ground A).

As a consequence, the auxiliary arm 17 can rotate on a horizontal plane, thus deploying in multiple arrangements, some of which are shown in unbroken lines or in dotted lines in FIGS. 4 and 6. Each one of such arrangements evidently corresponds to (at least) one different working position of the platform 12, which as has been seen is supported by the auxiliary arm 17. Furthermore, being articulated to the footing 18 (with a first end portion thereof), the auxiliary arm 17 can rotate about a second rotation axis D (shown for the sake of simplicity only in FIG. 11), with respect to the footing 18 (and to the post 14), thus obtaining further work positions for the platform 12 (which is supported at the second end portion of the auxiliary arm 17).

Two possible different arrangements of the auxiliary arm 17, which can be obtained with the rotation about the second axis D, are illustrated (one in unbroken lines and one in dotted lines) for each working configuration respectively in FIGS. 3 and 5.

FIGS. 3 and 5 show with E the direction of retraction/extraction of the members of the auxiliary arm 17, which makes it possible to obtain further possible work positions for the platform 12.

Advantageously, the platform 12 is associated with the means 11 (with the auxiliary arm 17 in particular) by way of a rotating stand 19, which is adapted to support the platform 12 in at least one first orientation which can be adopted in the first working configuration, and in a second orientation, which can be adopted in the second working configuration and can be obtained from the first orientation with a rotation of 180° of the rotating stand 19 (about a third rotation axis F, defined by the rotating element 19 itself and shown for example in FIGS. 3, 5 and 11). However, the possibility is not ruled out that the second orientation is obtained from the first orientation with a rotation of a different angle.

The ability of the platform 12 to rotate makes it possible to overturn it in order to adapt it to the new configuration deriving from the transition from the first working configuration to the second, or conversely, in a practical and easy manner.

It should be noted that all (or only some of) the movements described in the foregoing pages can be activated by the above mentioned actuation apparatus (preferably hydraulic).

It is emphasized that the present discussion relates to and claims protection for first of all the self-propelled vehicle 1, which is produced, marketed and/or used already comprising the vehicle 2, the main arm 6 and the apparatus 10, according to what is described and illustrated up to this point.

Likewise, the present discussion also relates to an apparatus 10, which can be installed on self-propelled vehicles 1 which comprise at least one vehicle 2, which can move over ground A and which can support at least one main telescopic arm 6, directly or indirectly coupled to the vehicle 2 with a first end. In other words, protection is also claimed for the production, marketing, use and/or offer for sale of the apparatus 10 alone, which is subsequently installed on a vehicle 1 obtained separately.

The apparatus 10 according to the invention therefore has the peculiarities already described above. In particular, it comprises means for movement 11 of a work platform 12, which is adapted to accommodate at least one operator. The means 11 are configured for moving the platform 12 with respect to the main arm 6 and for supporting the platform 12 in a plurality of different work positions. The means 11 can further be rotatably supported by the main arm 6 by way of an axial bearing 13 (which forms part of the apparatus 10 and is preferably of the center bearing type), which is adapted to support the means 11 in one configuration chosen from among at least one first working configuration and one second working configuration, which can be obtained from the first configuration with a rotation of the means 11 with respect to the main arm 6 equal to a predefined angle (preferably equal to 180°).

The operation of the self-propelled work vehicle and of the apparatus according to the invention is evident from the foregoing discussion.

The vehicle 1 can be used to enable an operator to carry out operations, maintenance, repairs and activities in general, on structures of various types located at different heights. To this end in fact, the operator can rise on the platform 12, thereby reaching one of a plurality of possible work positions, chosen to correspond to the exact point requiring intervention.

As seen, by conveniently configuring and moving the main arm 6 and the means 11, it is possible to confer a plurality of different configurations on these components, and this ensures maximum versatility, in that it makes it possible to choose in each instance the most appropriate working position, as a function obviously of the position at which to intervene and of the surrounding constraints.

In this context, the ability to rotate (in addition to the base 7) the main arm 6 and/or the auxiliary arm 17 has already been described, as the ability to act on their mutually extractable members, in order to obtain a great number of work positions.

What distinguishes the invention, in an entirely peculiar and innovative manner, is that such positions can be higher than the ground A and than the second end of the main arm 6, but also lower.

In more detail, first of all in a first working configuration of the means 11 (FIG. 3) the vehicle 1 makes it possible to work “positively”, i.e. the platform 12 can be raised (by a chosen height) above the ground A (above the resting surface of the vehicle 2) and above the second end of the main arm 6 (of the appendage 6a). In an entirely peculiar manner, by virtue of the adoption of the center bearing (or other axial bearing 13), interposed directly or indirectly between the main arm 6 and the means 11 (the post 14), the vehicle 1 can rapidly and easily pass from the first working configuration to a second working configuration, in which the means 11 (and the platform 12) are automatically rotated (preferably by 180°), with respect to the main axis B (preferably horizontal).

In this manner, in the second configuration of the means 11 (FIG. 5), the vehicle 1 makes it possible to work “negatively”, i.e. the platform 12 can be lowered (by a chosen height) at will, reaching work positions well below the second end of the main arm 6 and also below the ground A.

This result is obtained simply by controlling the rotation of the means 11 at the center bearing (or other axial bearing 13), therefore without needing any activities to disassemble and reassemble the components, as happens in conventional solutions.

In practice it has been found that the vehicle and the apparatus according to the invention fully achieve the set aim and objects, in that by virtue of the center bearing (or other axial bearing 13) they are capable of operating effectively both for lifting and for lowering the work platform 12.

The transition from the first to the second working configuration (and vice versa) is obtained completely automatically simply by actuating the rotation of the means 11, and this makes it possible to pass from the configuration adapted for lifting the platform 12 (including below road level) to the configuration adapted for lowering it, in an easy, rapid and safe manner.

The invention thus conceived is susceptible of numerous modifications and variations, all of which are within the scope of the appended claims. Moreover, all the details may be substituted by other technically equivalent elements.

In the embodiments illustrated, individual characteristics shown in relation to specific examples may in reality be substituted with other different characteristics, existing in other embodiments.

In practice, the materials employed, as well as the dimensions, may be any according to requirements and to the state of the art.

The disclosures in Italian Patent Application No. 102021000007268 from which this application claims priority are incorporated herein by reference.

1.-9. (canceled)

10. A self-propelled work vehicle, comprising at least one vehicle, which can move over ground and supports at least one main telescopic arm, which is coupled, directly or indirectly, with a first end to said vehicle and supports a work apparatus at an opposite end, wherein said apparatus comprises moving means for moving a work platform which are adapted to accommodate at least one operator, said moving means being configured for a movement of said platform with respect to said main arm and for a support of said platform in a plurality of different work positions, said moving means being supported rotatably by said main arm by way of an axial bearing, which is configured to support said moving means in one configuration chosen among at least one first working configuration and one second working configuration, which is configured to be obtained from said first configuration with a rotation of said means with respect to said main arm equal to a predefined angle.

11. The vehicle according to claim 10, wherein said axial bearing is a center bearing.

12. The vehicle according to claim 10, wherein said predefined angle is equal to 180°.

13. The vehicle according to claim 10, further comprising an apparatus for actuating the rotation of said moving means between said configurations, said apparatus being preferably of a hydraulic type.

14. The vehicle according to claim 10, wherein said moving means comprise a post which is anchored with a first end portion to a supporting element which is integral with a first annular race of said axial bearing, which is configured to rotate with respect to a second annular race of said axial bearing, which is integral with a second end of said main arm, opposite to said first end.

15. The vehicle according to claim 14, wherein said moving means comprise an auxiliary telescopic arm which is configured for the movement and a direct or indirect support of said platform.

16. The vehicle according to claim 15, wherein said auxiliary telescopic arm is articulated to a footing which is rotatably coupled to said post with a possibility of coaxial rotation with respect to said post.

17. The vehicle according to claim 10, wherein said platform is associated with said moving means by way of a rotating stand, which is configured to support said platform in at least one first orientation, which can be adopted in said first working configuration, and in a second orientation, which can be adopted in said second working configuration and can be obtained from said first orientation with a 180° rotation of said rotating stand.

18. A work apparatus installable on self-propelled work vehicles, which comprise at least one vehicle which can move over ground and supports at least one main telescopic arm, which is coupled, directly or indirectly, with a first end to the vehicle, further comprising moving means for moving a work platform which is configured to accommodate at least one operator, said moving means being configured for a movement of said platform with respect to the at least one main telescopic arm and for a support of said platform in a plurality of different work positions, said moving means being supportable rotatably by said at least one main telescopic arm by way of an axial bearing, which is configured to support said moving means in one configuration chosen from among at least one first working configuration and one second working configuration, which is configured to be obtained from said first configuration with a rotation of said moving means with respect to said main arm equal to a predefined angle.
